(19) United States
(12) Patent Application Publication
(10) Pub. No.: US 2021/0312729 A1
(43) Pub. Date: Oct. 7, 2021

(54) DISTRIBUTED AUTONOMOUS VEHICLE DATA LOGGER

(71) Applicant: GM Cruise Holdings LLC, San Francisco, CA (US)

(72) Inventors: James Smith, San Francisco, CA (US); Liam O'Shea Staskawicz, Berkeley, CA (US); Matthew Fornero, Oakland, CA (US)

(21) Appl. No.: 16/837,571

(22) Filed: Apr. 1, 2020

(51) Int. Cl. G07C 5/08; H04W 4/48; H04L 12/40

(52) U.S. Cl. CPC G07C 5/0841; H04L 2012/40215; H04L 12/40; H04W 4/48

(57) ABSTRACT

Systems, methods, and computer-readable media are provided for analyzing a distribution of sensors, compute elements, and data loggers within a logging system, generating a global policy based on the analyzing of the distribution of the sensors, the compute elements, and the data loggers of the logging system, providing the global policy to the sensors, the compute elements, and the data loggers of the logging system, transforming to local policies at each of the sensors, the compute elements, and the data loggers based on the global policy, and applying the transformed local policies at each of the sensors, the compute elements, and the data loggers to facilitate transmission of data from the sensors and the compute elements to the data loggers of the logging system.

### BACKGROUND

### 1. Technical Field

The subject technology provides solutions for embedded systems and in particular, for providing an embedded system with dynamic configurable data sources and loggers.

### 2. Introduction

An autonomous vehicle generates an extremely large amount of data from disparate sources (e.g., dozens of sensors and messages between computational nodes) that must be coalesced into a structured log in order to accurately capture the state of the autonomous vehicle at any given time. Due to the volume of data being logged, the act of capturing the data from the multiple sources consumes a significant amount of compute resources. If the limited number of compute resources are not managed correctly, issues of non-determinism can be introduced to a real-time system such as the autonomous vehicle.

Furthermore, the type, quantity, and priority of data being logged can change unexpectedly as the software and hardware components of a system for the autonomous vehicle is changed or updated. For example, black box loggers are not configurable and merely consume data regardless of type, quantity, and priority of the data to be logged.

As such, a need exists for an apparatus and a method that can efficiently and effectively provide a logging solution that can be flexible and configurable, thereby allowing for rapid iteration of data generation.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example environment that includes an autonomous vehicle in communication with a remote computing system, according to some aspects of the disclosed technology.

FIG. 2 illustrates an example schematic view of a logging system, according to some aspects of the disclosed technology.

FIG. 3 illustrates an example process for providing a thermal shock to a unit-under-test, according to some aspects of the disclosed technology.

FIG. 4 illustrates an example processor-based system with which some aspects of the subject technology can be implemented.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology. In some instances, well-known structures and devices are shown in block diagram form in order to facilitate describing one or more aspects. Further, it is to be understood that functionality that is described as being carried out by certain system components may be performed by more or fewer components than shown.

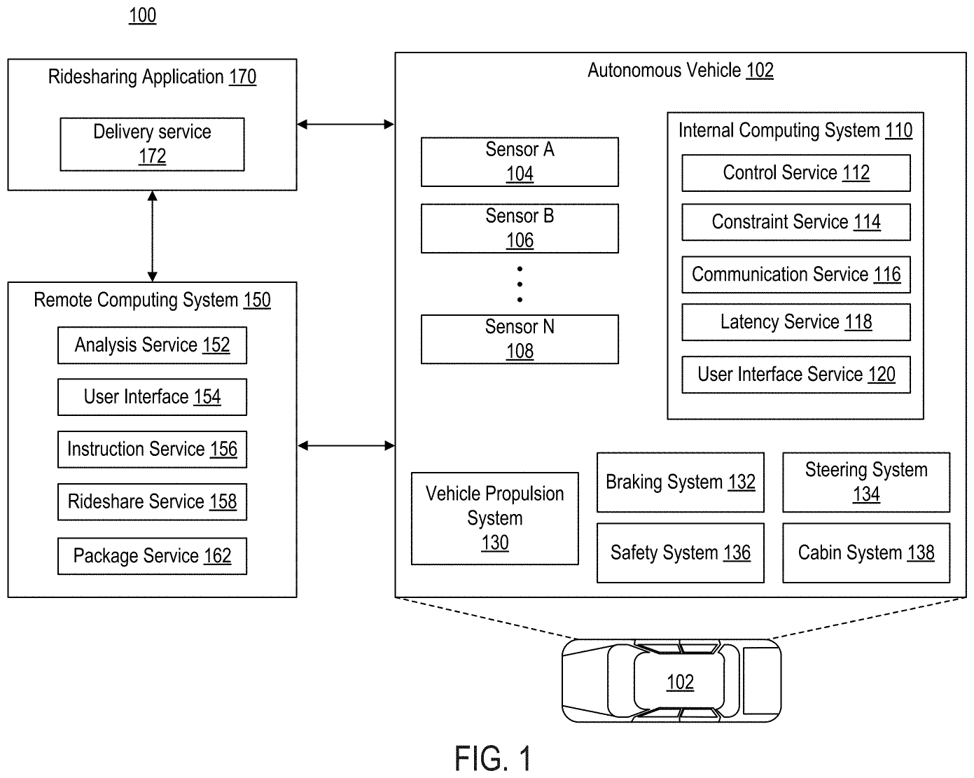

FIG. 1 illustrates an example autonomous vehicle environment 100. The example autonomous vehicle environment 100 includes an autonomous vehicle 102, a remote computing system 150, and a ridesharing application 170. The autonomous vehicle 102, remote computing system 150, and ridesharing application 170 can communicate with each other over one or more networks, such as a public network (e.g., a public cloud, the Internet, etc.), a private network (e.g., a local area network, a private cloud, a virtual private network, etc.), and/or a hybrid network (e.g., a multi-cloud or hybrid cloud network, etc.).

The autonomous vehicle 102 can navigate about roadways without a human driver based on sensor signals generated by sensors 104-108 on the autonomous vehicle 102. The sensors 104-108 on the autonomous vehicle 102 can include one or more types of sensors and can be arranged about the autonomous vehicle 102. For example, the sensors 104-108 can include, without limitation, one or more inertial measuring units (IMUs), one or more image sensors (e.g., visible light image sensors, infrared image sensors, video camera sensors, surround view camera sensors, etc.), one or more light emitting sensors, one or more global positioning system (GPS) devices, one or more radars, one or more light detection and ranging sensors (LIDARs), one or more sonars, one or more accelerometers, one or more gyroscopes, one or more magnetometers, one or more altimeters, one or more tilt sensors, one or more motion detection sensors, one or more light sensors, one or more audio sensors, etc. In some implementations, sensor 104 can be a radar, sensor 106 can be a first image sensor (e.g., a visible light camera), and sensor 108 can be a second image sensor (e.g., a thermal camera). Other implementations can include any other number and type of sensors.

The autonomous vehicle 102 can include several mechanical systems that are used to effectuate motion of the autonomous vehicle 102. For instance, the mechanical systems can include, but are not limited to, a vehicle propulsion system 130, a braking system 132, and a steering system 134. The vehicle propulsion system 130 can include an electric motor, an internal combustion engine, or both. The braking system 132 can include an engine brake, brake pads, actuators, and/or any other suitable componentry configured to assist in decelerating the autonomous vehicle 102. The steering system 134 includes suitable componentry configured to control the direction of movement of the autonomous vehicle 102 during navigation.

The autonomous vehicle 102 can include a safety system 136. The safety system 136 can include lights and signal indicators, a parking brake, airbags, etc. The autonomous vehicle 102 can also include a cabin system 138, which can include cabin temperature control systems, in-cabin entertainment systems, etc.

The autonomous vehicle 102 can include an internal computing system 110 in communication with the sensors 104-108 and the systems 130, 132, 134, 136, and 138. The internal computing system 110 includes one or more processors and at least one memory for storing instructions executable by the one or more processors. The computer-executable instructions can make up one or more services for controlling the autonomous vehicle 102, communicating with remote computing system 150, receiving inputs from passengers or human co-pilots, logging metrics regarding data collected by sensors 104-108 and human co-pilots, etc.

The internal computing system 110 can include a control service 112 configured to control operation of the vehicle propulsion system 130, the braking system 132, the steering system 134, the safety system 136, and the cabin system 138. The control service 112 can receive sensor signals from the sensors 104-108 can communicate with other services of the internal computing system 110 to effectuate operation of the autonomous vehicle 102. In some examples, control service 112 may carry out operations in concert with one or more other systems of autonomous vehicle 102.

The internal computing system 110 can also include a constraint service 114 to facilitate safe propulsion of the autonomous vehicle 102. The constraint service 116 includes instructions for activating a constraint based on a rule-based restriction upon operation of the autonomous vehicle 102. For example, the constraint may be a restriction on navigation that is activated in accordance with protocols configured to avoid occupying the same space as other objects, abide by traffic laws, circumvent avoidance areas, etc. In some examples, the constraint service 114 can be part of the control service 112.

The internal computing system 110 can also include a communication service 116. The communication service 116 can include software and/or hardware elements for transmitting and receiving signals to and from the remote computing system 150. The communication service 116 can be configured to transmit information wirelessly over a network, for example, through an antenna array or interface that provides cellular (long-term evolution (LTE), 3rd Generation (3G), 5th Generation (5G), etc.) communication.

In some examples, one or more services of the internal computing system 110 are configured to send and receive communications to remote computing system 150 for reporting data for training and evaluating machine learning algorithms, requesting assistance from remote computing system 150 or a human operator via remote computing system 150, software service updates, ridesharing pickup and drop off instructions, etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150, as information can quickly become too stale to be actionable. When the latency service 118 determines that a response has not been received within a threshold period of time, the latency service 118 can enable other systems of autonomous vehicle 102 or a passenger to make decisions or provide needed feedback.

The internal computing system 110 can also include a user interface service 120 that can communicate with cabin system 138 to provide information or receive information to a human co-pilot or passenger. In some examples, a human co-pilot or passenger can be asked or requested to evaluate and override a constraint from constraint service 114. In other examples, the human co-pilot or passenger may wish to provide an instruction to the autonomous vehicle 102 regarding destinations, requested routes, or other requested operations.

As described above, the remote computing system 150 can be configured to send and receive signals to and from the autonomous vehicle 102. The signals can include, for example and without limitation, data reported for training and evaluating services such as machine learning services, data for requesting assistance from remote computing system 150 or a human operator, software service updates, rideshare pickup and drop off instructions, etc.

The remote computing system 150 can include an analysis service 152 configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102.

The remote computing system 150 can also include a user interface service 154 configured to present metrics, video, images, sounds reported from the autonomous vehicle 102 to an operator of remote computing system 150, maps, routes, navigation data, notifications, user data, vehicle data, software data, and/or any other content. User interface service 154 can receive, from an operator, input instructions for the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing applications 170 operating on computing devices, such as tablet computers, laptop computers, smartphones, head-mounted displays (HMDs), gaming systems, servers, smart devices, smart wearables, and/or any other computing devices. In some cases, such computing devices can be passenger computing devices. The rideshare service 158 can receive from passenger ridesharing app 170 requests, such as user requests to be picked up or dropped off, and can dispatch autonomous vehicle 102 for a requested trip.

The rideshare service 158 can also act as an intermediary between the ridesharing app 170 and the autonomous vehicle 102. For example, rideshare service 158 can receive from a passenger instructions for the autonomous vehicle 102, such as instructions to go around an obstacle, change routes, honk the horn, etc. The rideshare service 158 can provide such instructions to the autonomous vehicle 102 as requested.

The remote computing system 150 can also include a package service 162 configured to interact with the ridesharing application 170 and/or a delivery service 172 of the ridesharing application 170. A user operating ridesharing application 170 can interact with the delivery service 172 to specify information regarding a package to be delivered using the autonomous vehicle 102. The specified information can include, for example and without limitation, package dimensions, a package weight, a destination address, delivery instructions (e.g., a delivery time, a delivery note, a delivery constraint, etc.), and so forth.

The package service 162 can interact with the delivery service 172 to provide a package identifier to the user for package labeling and tracking. Package delivery service 172 can also inform a user of where to bring their labeled package for drop off. In some examples, a user can request the autonomous vehicle 102 come to a specific location, such as the user's location, to pick up the package. While delivery service 172 has been shown as part of the ridesharing application 170, it will be appreciated by those of ordinary skill in the art that delivery service 172 can be its own separate application.

One beneficial aspect of utilizing autonomous vehicle 102 for both ridesharing and package delivery is increased utilization of the autonomous vehicle 102. Instruction service 156 can continuously keep the autonomous vehicle 102 engaged in a productive itinerary between rideshare trips by filling what otherwise would have been idle time with productive package delivery trips.

Generally, logging of data at each node of a system can require large amounts of storage media on all devices, which can drive up cost. These types of system can also require a more complicated data ex-filtration strategy versus a centrally managed logging-type system. There is also the potential of data loss if a single node fails because all of the data is being stored by the single node. For example, logging of data at compute nodes can also require large amounts of storage media on compute devices. Logging resource costs can be exceptionally high and interfere with real-time performance, thereby possibly losing data if the single node fails. The other alternative is to not log the data at all. For example, some embedded systems do not store data locally and provide the data through a data stream to an external server. However, such methods are infeasible for autonomous vehicles because the autonomous vehicles are mobile and the bandwidth requirements are exceptionally large. The autonomous vehicles may also require logged data to meet safety standards.

As such, a need exists for an apparatus and a method that can efficiently and effectively provide a logging solution that can be flexible and configurable, thereby allowing for rapid iteration of data generation.

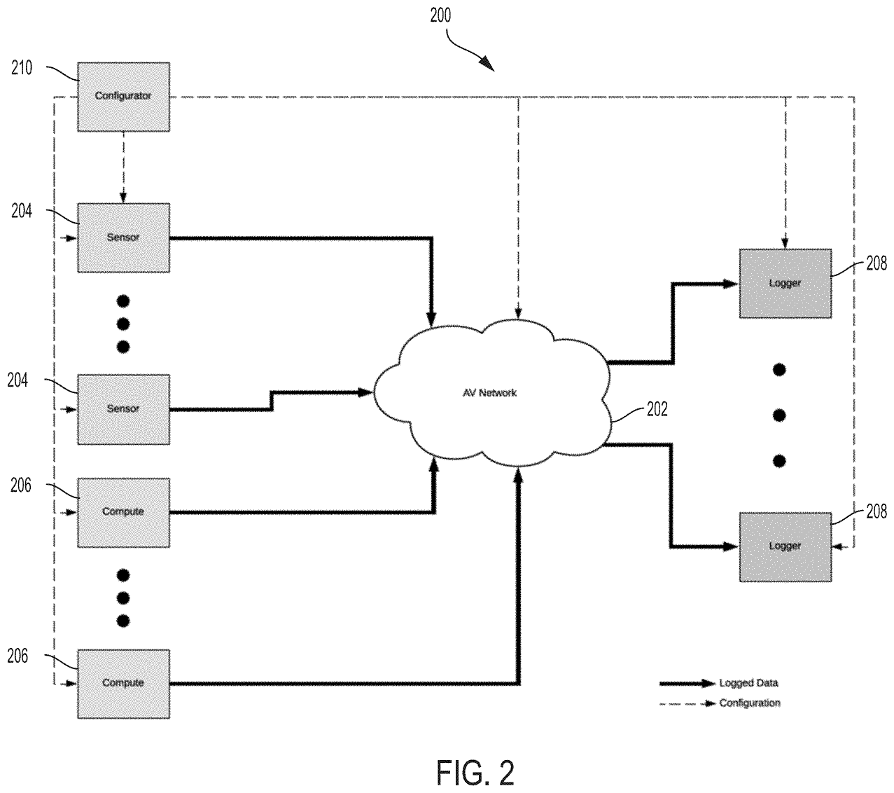

FIG. 2 illustrates an example schematic view of a logging system 200, according to some aspects of the disclosed technology. The logging system 200 can enable embedded devices in an autonomous vehicle system and stream data to a recording device to ensure safe and reliable capture of the state of the autonomous vehicle. In some cases, the logging system 200 can utilize distributed compute that may include a plurality of producers and consumers of data at various nodes.

In some instances, the logging system 200 can include an autonomous vehicle network 202 that can link together various components as provided below. The logging system 200 further can include data sources that can generate data and send the data back to the autonomous vehicle network 202. The data sources can include sensors 204 that produce data. Autonomous vehicles can navigate about roadways without a human driver based upon sensor signal output by sensors 204 of the autonomous vehicle. The autonomous vehicle can further include a plurality of sensors 204 as shown in FIG. 2. The sensors 204 also can be different types of sensors and can be arranged about the autonomous vehicle. For example, a first sensor may be a camera sensor, while a second sensor can be a LiDAR sensor. Other sensors 204 can include a radar sensor, a global positioning system (GPS) sensor, inertial measurement units (IMU), an infrared sensor, a laser sensor, a sonar sensor, or any other sensor suitable for the intended purpose and understood by a person of ordinary skill in the art.

The data sources can further include compute elements 206 that can produce and consume data. For example, the compute elements 206 can include network egress, network ingress, routing, storage, or any other compute element suitable for the intended purpose and understood by a person of ordinary skill in the art. In some instances, the compute elements 206 can include automated driving system computers (ADSC) that can be configured to execute autonomous vehicle robotics software. The autonomous vehicle robotics software can include autonomous vehicle behavioral logic code that can be executed by the ADSC. In other instances, some functionality may be specific to a particular network. For example, external sensor drivers can be executed on the ADSC and ingest sensor data into the autonomous vehicle stack, which may be from the network. Moreover, additional code can utilize autonomous vehicle commands and provide them over the network to advanced driving integration modules.

In some instances, the compute elements 206 also can include advanced driving integration modules (ADIM) that can be dedicated computes, which interface between the autonomous vehicle's controller area network (CAN) bus and the autonomous vehicle network. This type of interconnection can relay commands from the autonomous vehicle stack to the autonomous vehicle's controllers that facilitate movement of the autonomous vehicle.

The logging system 200 can further include data loggers 208 that can be configured to record data received from the autonomous vehicle network 202. The autonomous vehicle network 202 and the data loggers 208 can each include a processor and memory to process and store the data received from the data sources 204, 206. In some instances, the autonomous vehicle network 202, the sensors 204, the compute elements 206, the data loggers 208, and the configurator 210 can be a part of an autonomous vehicle system. In other cases, the data loggers 208 can be external to the autonomous vehicle and the data from the sensors 204 and the compute elements 206 can be transmitted by the autonomous vehicle network 202 to the external data loggers 208.

In some instances, the logging system 200 can include a configurator 210 that can configure the sensors 204, the compute elements 206, and the data loggers 208 based on data location, data rates, and priority of the data received by the autonomous vehicle network 202. For example, the configurator 210 can be configured to analyze the distribution of the sensors 204, the compute elements 206, and the data loggers 208 to generate a configuration that can then be applied across the sensors 204, the compute elements 206, and the data loggers 208. In some instances, the configuration can be based on the analysis of the distribution of the sensors 204, the compute elements 206, and the data loggers 208 to generate a global policy that can be applied to the sensors 204, the compute elements 206, and the data loggers 208.

The configuration/global policy can allow the sensors 204, the compute elements 206, and the data loggers 208 to adjust and open communication channels to effectively utilize resources that can be based on the characteristics of the distributed logging system 200. Regarding the sensors 204 and the compute elements 206, the global policy can prioritize and aggregate all of the data sources 204, 206 to the autonomous vehicle network 202. Regarding the data loggers 208, the global policy can identify and prioritize the various data streams to an appropriate storage location so that higher priority data is stored by the data logger to ensure its correct recordation. By providing higher priority to specified data sources 204, 206, the autonomous vehicle network 202 can redistribute channels to the data loggers 208 accordingly such that the prioritization and distribution of the data streams ensures safe and reliable capture of the state of the autonomous vehicle.

The logging system 200 can also provide dynamic configuration of the sensors 204, the compute elements 206, and the data loggers 208 into the logging system 200. For example, the logging system 200 can provide distributed quality of service (QoS) control across the sensors 204, the compute elements 206, the autonomous vehicle network 202, and the data loggers 208. The distributed QoS control can allow for redundant logging of data as needed or requested.

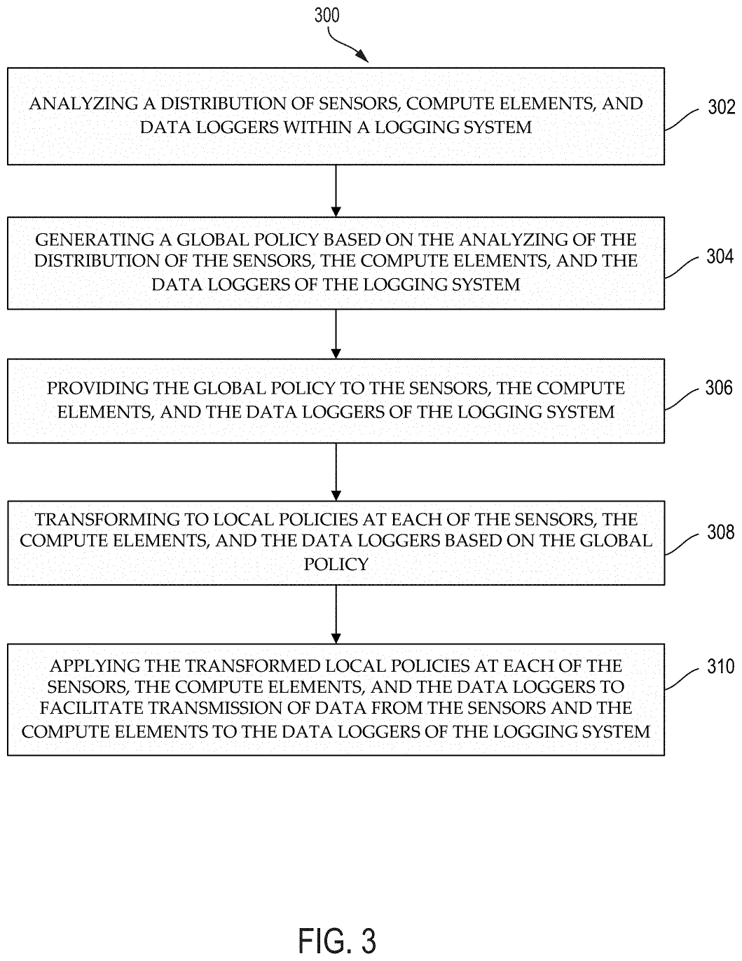

Having disclosed some example system components and concepts, the disclosure now turns to FIG. 3, which illustrate example method 300 for distributing data within a system. The steps outlined herein are exemplary and can be implemented in any combination thereof, including combinations that exclude, add, or modify certain steps.

At step 302, the method 300 can include analyzing a distribution of sensors, compute elements, and data loggers within a logging system. The compute elements can include at least one of network egress, network ingress, routing, and storage. The analyzing of the distribution of sensors, compute elements, and data loggers can include determining the number of components, the priority of each component, and the type of components within the logging system.

At step 304, the method 300 can include generating a global policy based on the analyzing of the distribution of the sensors, the compute elements, and the data loggers of the logging system. The global policy can be a list of instructions to be utilized by the sensors, the compute elements, the data loggers, and an autonomous vehicle network of the logging system. A configurator of the logging system can generate the global policy within the logging system.

At step 306, the method 300 can include providing the global policy to the sensors, the compute elements, and the data loggers of the logging system. The configurator or the autonomous vehicle network can provide the global policy to the sensors, the compute elements, and the data loggers of the logging system.

At step 308, the method 300 can include transforming to local policies at each of the sensors, the compute elements, and the data loggers based on the global policy. Each of the components of the logging system can update, adjust, or revise their respective local policies of data distribution based on the global policy of the logging system.

At step 310, the method 300 can include applying the transformed local policies at each of the sensors, the compute elements, and the data loggers to facilitate transmission of data from the sensors and the compute elements to the data loggers of the logging system. Application of the transformed local policies of the sensors, the compute elements, and the data loggers can determine which data of the sensors and the compute elements goes to which data logger. For example, the transformed local policies may determine that data (e.g., high priority data) from a first sensor is to be processed and stored by a first data logger, while data (e.g., low priority data) from a first compute element is to be processed and stored by a second data logger. Other instances also can include low priority data only being processed and stored by a data logger, if there is enough storage capacity, after the high priority data is processed and stored by the data logger.

The logging system can further include an autonomous vehicle network that communicatively couples the sensors, the compute elements, and the data loggers within an autonomous vehicle. Each of the data loggers and the autonomous vehicle network can include a processor and memory.

The global policy can include instructions prioritizing data from each of the sensors and the compute elements. Data with a higher priority from the sensors or compute elements can be stored at the data loggers, while data with a lower priority from the sensors or compute elements may not be stored at the data loggers. The data with the higher priority from the sensors or compute elements can be stored on the memory of the data loggers and not on the memory of the autonomous vehicle network.

The logging system can also include dynamically revising the global policy based on changes to the logging system. For example, if new sensors are added to the logging system or certain compute elements are newly determined to be of high priority, the logging system can automatically revise the global policy for the components of the logging system to determine which data from the sensors and the compute elements go to which data logger, if at all.

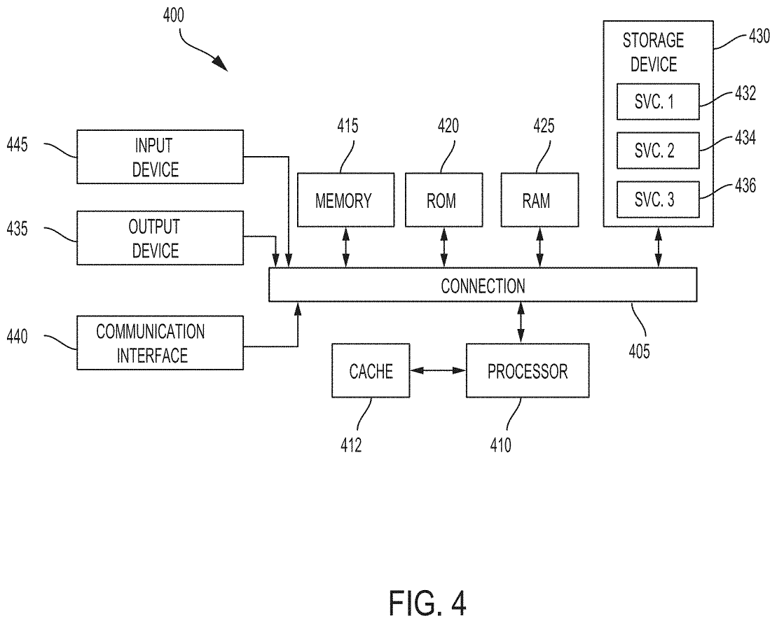

FIG. 4 illustrates an example computing system 400 which can be, for example, any computing device making up internal computing system 110, remote computing system 150, a passenger device executing rideshare application 170, or any other computing device. In FIG. 4, the components of the computing system 400 are in communication with each other using connection 405. Connection 405 can be a physical connection via a bus, or a direct connection into processor 410, such as in a chipset architecture. Connection 1205 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read-only memory (ROM) 420 and random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement, and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

What is claimed is:

1. A computer-implemented method comprising:
analyzing a distribution of sensors, compute elements, and data loggers within a logging system;
generating a global policy based on the analyzing of the distribution of the sensors, the compute elements, and the data loggers of the logging system;
providing the global policy to the sensors, the compute elements, and the data loggers of the logging system;
transforming to local policies at each of the sensors, the compute elements, and the data loggers based on the global policy; and
applying the transformed local policies at each of the sensors, the compute elements, and the data loggers to facilitate transmission of data from the sensors and the compute elements to the data loggers of the logging system.

2. The computer-implemented method of claim 1, wherein the compute elements include at least one of network egress, network ingress, routing, and storage.

3. The computer-implemented method of claim 1, wherein the logging system further includes an autonomous vehicle network that communicatively couples the sensors, the compute elements, and the data loggers within an autonomous vehicle.

4. The computer-implemented method of claim 3, wherein each of the data loggers and the autonomous vehicle network includes a processor and memory.

5. The computer-implemented method of claim 4, wherein the global policy includes instructions prioritizing data from each of the sensors and the compute elements.

6. The computer-implemented method of claim 5, wherein data with a higher priority from the sensors or compute elements is stored at the data loggers, while data with a lower priority from the sensors or compute elements is not stored at the data loggers.

7. The computer-implemented method of claim 6, wherein the data with the higher priority from the sensors or compute elements is stored on the memory of the data loggers and not on the memory of the autonomous vehicle network.

8. A logging system comprising:
one or more processors; and
at least one computer-readable storage medium having stored therein instructions which, when executed by the one or more processors, cause the logging system to:
analyze a distribution of sensors, compute elements, and data loggers within the logging system;
generate a global policy based on the analysis of the distribution of the sensors, the compute elements, and the data loggers of the logging system;
provide the global policy to the sensors, the compute elements, and the data loggers of the logging system;
transform to local policies at each of the sensors, the compute elements, and the data loggers based on the global policy; and
apply the local policies transformed at each of the sensors, the compute elements, and the data loggers to facilitate transmission of data from the sensors and the compute elements to the data loggers of the logging system.

9. The system of claim 8, wherein the compute elements include at least one of network egress, network ingress, routing, and storage.

10. The system of claim 8, wherein the logging system further includes an autonomous vehicle network that communicatively couples the sensors, the compute elements, and the data loggers within an autonomous vehicle.

11. The system of claim 10, wherein each of the data loggers and the autonomous vehicle network includes a processor and memory.

12. The system of claim 11, wherein the global policy includes instructions prioritizing data from each of the sensors and the compute elements.

13. The system of claim 12, wherein data with a higher priority from the sensors or compute elements is stored at the data loggers, while data with a lower priority from the sensors or compute elements is not stored at the data loggers.

14. The system of claim 13, wherein the data with the higher priority from the sensors or compute elements is stored on the memory of the data loggers and not on the memory of the autonomous vehicle network.

15. A non-transitory computer-readable storage medium comprising:
instructions stored on the non-transitory computer-readable storage medium, the instructions, when executed by one more processors, cause the one or more processors to:
analyze a distribution of sensors, compute elements, and data loggers within a logging system;
generate a global policy based on the analysis of the distribution of the sensors, the compute elements, and the data loggers of the logging system;
provide the global policy to the sensors, the compute elements, and the data loggers of the logging system;
transform to local policies at each of the sensors, the compute elements, and the data loggers based on the global policy; and
apply the local policies transformed at each of the sensors, the compute elements, and the data loggers to facilitate transmission of data from the sensors and the compute elements to the data loggers of the logging system.

16. The non-transitory computer-readable storage medium of claim 15, wherein the compute elements include at least one of network egress, network ingress, routing, and storage.

17. The non-transitory computer-readable storage medium of claim 15, wherein the logging system further includes an autonomous vehicle network that communicatively couples the sensors, the compute elements, and the data loggers within an autonomous vehicle.

18. The non-transitory computer-readable storage medium of claim 17, wherein each of the data loggers and the autonomous vehicle network includes a processor and memory.

19. The non-transitory computer-readable storage medium of claim 18, wherein the global policy includes instructions prioritizing data from each of the sensors and the compute elements.

20. The non-transitory computer-readable storage medium of claim 19, wherein data with a higher priority from the sensors or compute elements is stored at the data loggers, while data with a lower priority from the sensors or compute elements is not stored at the data loggers,
wherein the data with the higher priority from the sensors or compute elements is stored on the memory of the data loggers and not on the memory of the autonomous vehicle network.
